(19) United States
(12) Patent Application Publication
(10) Pub. No.: US 2007/0051753 A1
(43) Pub. Date: Mar. 8, 2007

(54) Apparatus for controlling supply of liquid contained in a container

(76) Inventor: Fu-San Lu, Tainan City (TW)

Correspondence Address: LADAS & PARRY LLP, 224 SOUTH MICHIGAN AVENUE, SUITE 1600, CHICAGO, IL, 60604, US

(21) Appl. No.: 11/210,121

(22) Filed: Aug. 23, 2005

(51) Int. Cl. B67D 5/06; G01F 11/28

(52) U.S. Cl. 222/181.1; 222/453; 222/476; 222/129

(57) ABSTRACT

An apparatus for controlling supply of liquid contained in a container includes an elongate rail frame mounted uprightly on a base and formed with an upright guide slot. A controller is mounted on the rail frame, includes an upper inlet portion engaging fittingly an opening of the container so as to allow flow of the liquid from the container thereinto, and is operable so as to discharge the liquid from a lower outlet portion. A biasing member biases an operating rod to move downwardly relative to the base so as to clamp the container between an abutting rod portion of the operating rod and the controller. An engaging block is formed on the operating rod and is movable within the guide slot to engage a stop block disposed fixedly on the rail frame.

### BACKGROUND OF THE INVENTION

1. Field of the Invention

The invention relates to a control apparatus, more particularly to an apparatus for controlling supply of liquid contained in a container.

2. Description of the Related Art

Referring to FIGS. 1 to 3, a conventional apparatus 1 for controlling supply of liquid contained in four containers 2 is shown to include a base 11, four elongate rail frames 12, four controller 13, four operating rods 14, and four coiled compression springs 15.

The rail frames 12 are mounted fixedly and uprightly on the base 11 and are spaced apart from each other. Each rail frame 12 has an upper end 122, and is formed with an upright guide slot 121 extending downwardly from the upper end 122. The controllers 13 are mounted respectively on the rail frames 12. Each controller 13 has an upper inlet portion engaging fittingly an opening of the respective container 2 so as to allow flow of the liquid from the respective container 2 into the upper inlet portion, and is operable so as to discharge an amount of the liquid from a lower outlet portion. Each operating rod 14 has an insertion rod portion 141 inserted movably into the guide slot 121 of a corresponding one of the rail frames 12, and an abutting rod portion 142 connected integrally to a top end of the insertion rod portion 141, disposed above a corresponding of the controllers 13 and abutting against the corresponding container 2 when the latter is disposed between the abutting rod portion 142 and the upper inlet portion of the corresponding controller 13. Each compression spring 15 is mounted between a corresponding one of the rail frames 12 and a corresponding one of the operating rods 14 for biasing the corresponding operating rod 14 to move downwardly so as to clamp the container 2 between the abutting rod portion 142 of the corresponding operating rod 14 and the corresponding controller 13.

The following are some of the drawbacks of the conventional apparatus 1:

1. When one operating rod 14 is moved upwardly to perform placement/removal of the container 2 on/from the controller 13, the insertion rod portion 141 of the operating rod 14 may separate from the rail frame 12, as shown in FIG. 4.

2. Since the upper ends 122 of the rail frames 12 cannot be effectively positioned, the rail frames 12 may deform during operation of the operating rods 14.

### SUMMARY OF THE INVENTION

Therefore, the object of the present invention is to provide an apparatus for controlling supply of liquid contained in a container that can eliminate the aforesaid drawbacks of the prior art.

According to the present invention, there is provided an apparatus for controlling supply of liquid contained in a container. The container has an opening. The apparatus comprises:

a base;

an elongate rail frame mounted fixedly and uprightly on the base and formed with an upright guide slot extending downwardly from an upper end of the rail frame;

a controller mounted on a lower end of the rail frame and including an upper inlet portion adapted to engage fittingly the opening of the container so as to allow flow of the liquid from the container into the upper inlet portion, and a lower outlet portion, the controller being operable so as to discharge an amount of the liquid from the lower outlet portion;

an operating rod having an insertion rod portion inserted movably into the guide slot via the upper end of the rail frame, and an abutting rod portion connected integrally to a top end of the insertion rod portion, disposed above the controller, and adapted to abut against the container when the container is disposed between the abutting rod portion of the operating rod and the upper inlet portion of the controller;

a biasing member mounted between the rail frame and the operating rod for biasing the operating rod to move downwardly so as to clamp the container between the abutting rod portion of the operating rod and the controller when the container is disposed between the abutting rod portion of the operating rod and the upper inlet portion of the controller; and

a positioning unit including a position-limiting member disposed fixedly on the rail frame and formed with an integral stop block that extends into the guide slot in the rail frame, and an engaging block formed on the insertion rod portion of the operating rod and disposed under the stop block, the engaging block being movable within the guide slot to engage the stop block so as to prevent removal of the operating rod from the rail frame when the operating rod is moved upwardly.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional apparatus for controlling supply of liquid contained in four containers;

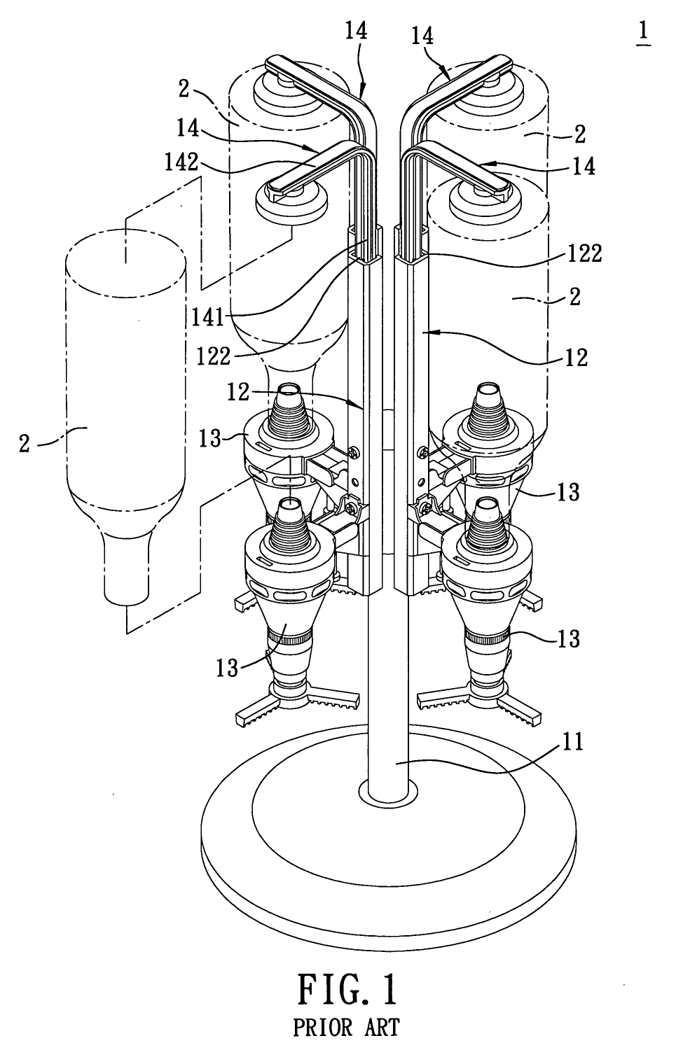

FIG. 2 is a partly sectional schematic view of the conventional apparatus of FIG. 1;

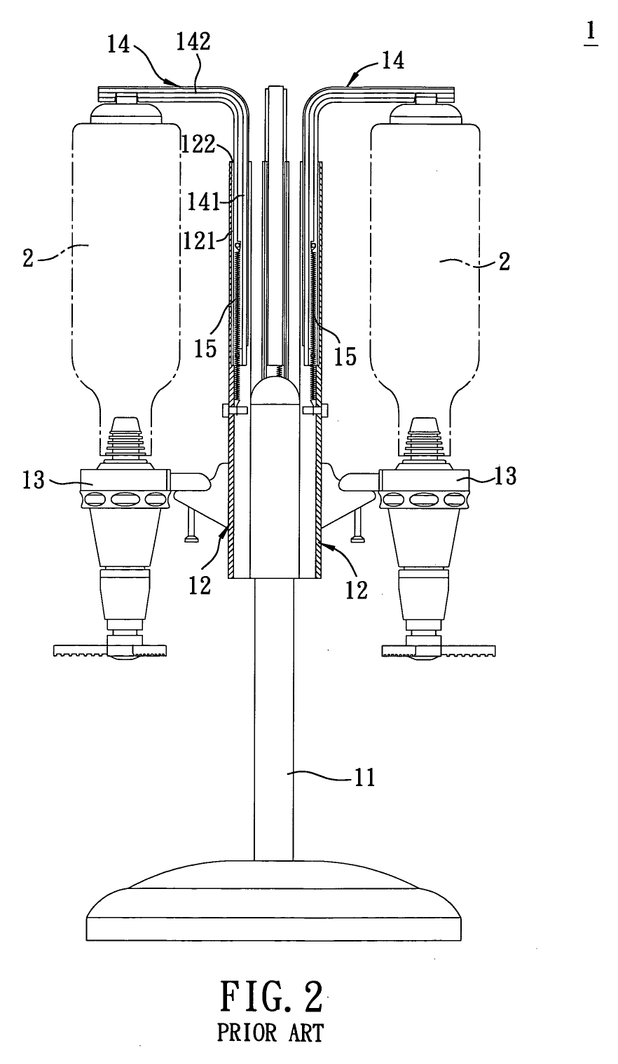

FIG. 3 is a schematic top view of the conventional apparatus of FIG. 1;

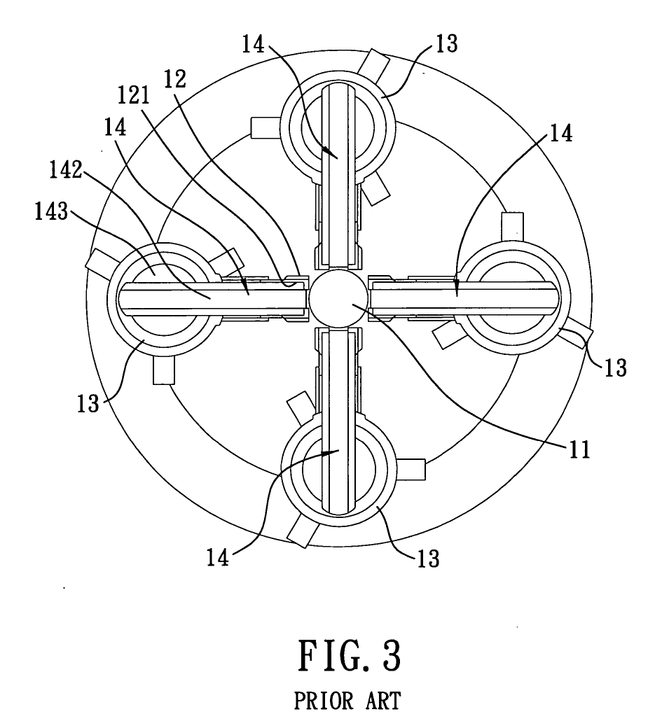

FIG. 4 is a fragmentary, partly sectional, schematic view illustrating the conventional apparatus in a state, where an operating rod separates from a rail frame;

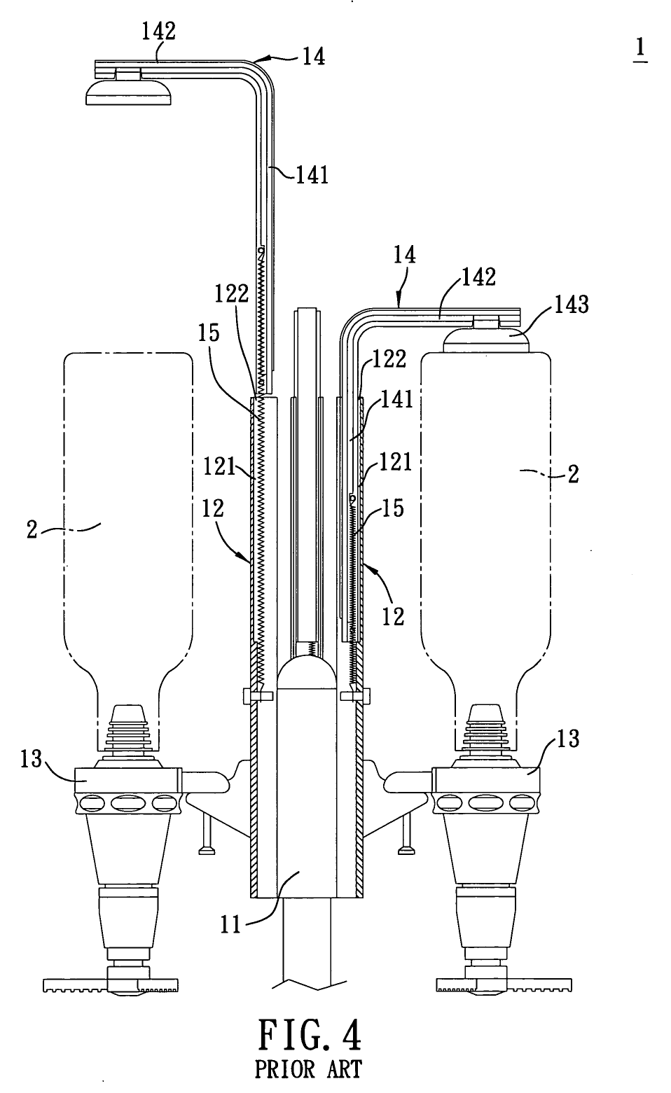

FIG. 5 is a perspective view showing the preferred embodiment of an apparatus for controlling supply of liquid contained in each container according to the present invention;

FIG. 6 is a fragmentary, partly sectional, schematic view of the preferred embodiment;

FIG. 7 is a fragmentary schematic top view of the preferred embodiment;

FIG. 8 is an exploded, fragmentary perspective view showing an operating rod, a biasing member, a rail frame and a positioning unit of the preferred embodiment; and

FIG. 9 is a fragmentary, partly sectional schematic view illustrating the preferred embodiment in a state, where the operating rod is retained on the rail frame by the positioning unit when moving upwardly.

### DETAILED DESCRIPTION OF THE PREFERRED EMBODIMENT

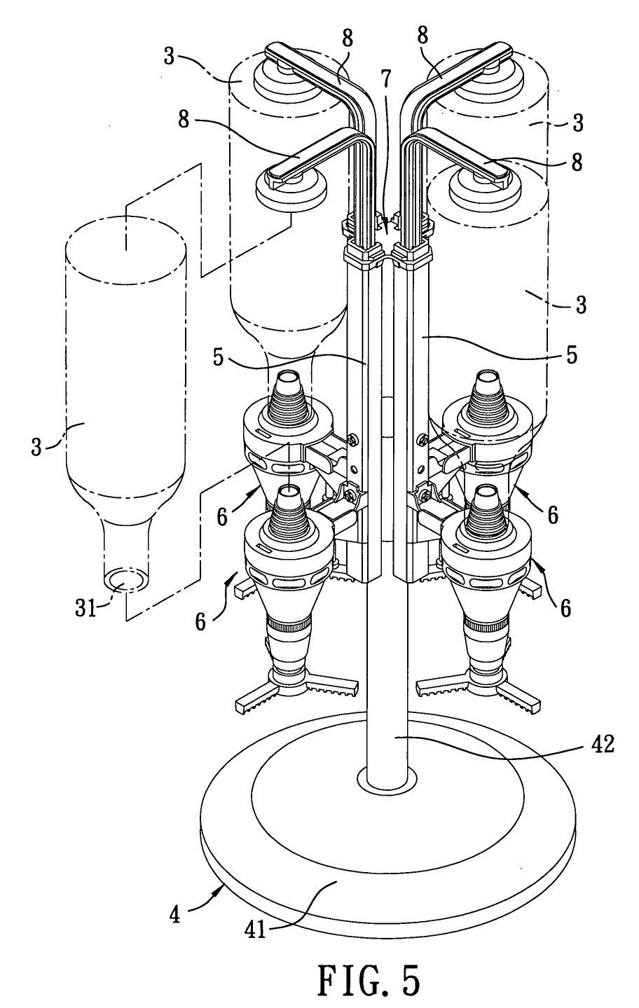

Referring to FIG. 5, the preferred embodiment of an apparatus for controlling supply of liquid contained in four containers 3 according to the present invention is shown. In this embodiment, the liquid (not shown) can be a kind of beverage, and each container 3 has an opening 31. The apparatus includes a base 4, four angularly equidistant elongate rail frames 5, four controllers 6, four operating rods 8, four biasing members 9, and a positioning unit.

The base 4 has a disk portion 41, and a supporting rod portion 42 mounted fixedly and uprightly on the disk portion 41.

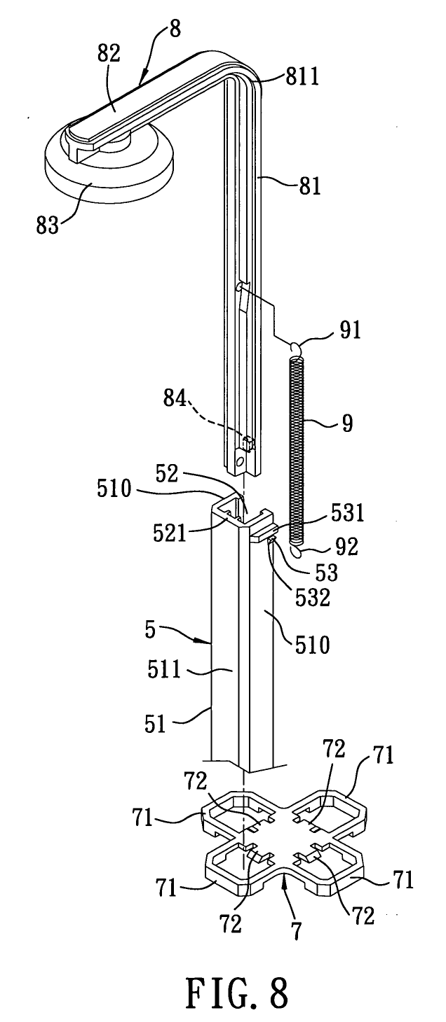

The rail frames 5 are mounted fixedly and uprightly on the supporting rod portion 42 of the base 4, and are spaced apart from each other. With further reference to FIG. 8, in this embodiment, each rail frame 5 includes a U-shaped cross-sectioned vertical rod 51 that is disposed fixedly on the supporting rod portion 42 of the base 4 and that has parallel first wall portions 510, and a second wall portion 511 interconnecting the first wall portions 510 and cooperating with the first wall portions 510 to define a guide slot 52. The guide slot 52 thus extends downwardly from an upper end 521 of the rail frame 5. Each of the first wall portions 511 has an outer surface formed with parallel first and second lugs 531, 532 that are disposed in proximity to an upper end of the vertical rod 51 (i.e., the upper end 521 of the rail frame 5) and that are spaced apart from each other so as to define an engaging groove 53 therebetween.

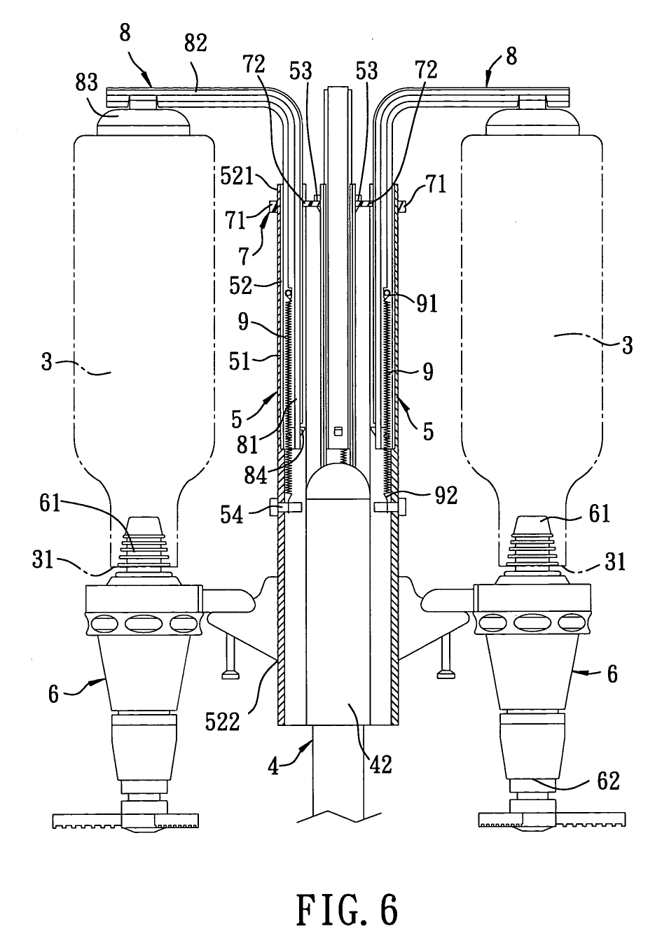

Referring to FIG. 6, each of the controllers 6 is mounted on a lower end 522 of a corresponding one of the rail frames 5, and includes an upper inlet portion 61 adapted to engage fittingly the opening 31 of the corresponding container 3 so as to allow flow of the liquid from the corresponding container 3 into the upper inlet portion 61, and a lower outlet portion 62. Each controller 6 is operable so as to discharge an amount of the liquid from the lower outlet portion 62 in a known manner.

Referring to FIGS. 6 and 8, each of the operating rods 8 is inverted L-shaped in this embodiment, has an insertion rod portion 81 inserted movably into the guide slot 52 via the upper end 521 of a corresponding one of the rail frames 5, and an abutting rod portion 82 connected integrally to a top end 811 of the insertion rod portion 81, disposed above a corresponding one of the controllers 6, and adapted to abut against the corresponding container 3 when the latter is disposed between the abutting rod portion 82 and the upper inlet portion 61 of the corresponding one of the controllers 6. In this embodiment, the abutting rod portion 82 of each operating rod 8 is mounted with an abutting cap 83 for abutting against the corresponding container 3.

Each of the biasing members 9 is mounted between a corresponding one of the rail frames 5 and a corresponding one of the operating rods 8 for biasing the corresponding one of the operating rods 8 to move downwardly so as to clamp the corresponding container 3 between the abutting rod portion 82 of the corresponding one of the operating rods 8 and the corresponding one of the controllers 6. In this embodiment, each biasing member 9 is a coiled compression spring that is disposed in the guide slot 52 of the corresponding one of the rail frames 5 and that has opposite ends 91, 92 connected respectively to a middle portion of the insertion rod portion 81 of the corresponding one of the operating rods 8 and an insertion bolt 54 on the corresponding one of the rail frames 5, as shown in FIG. 6.

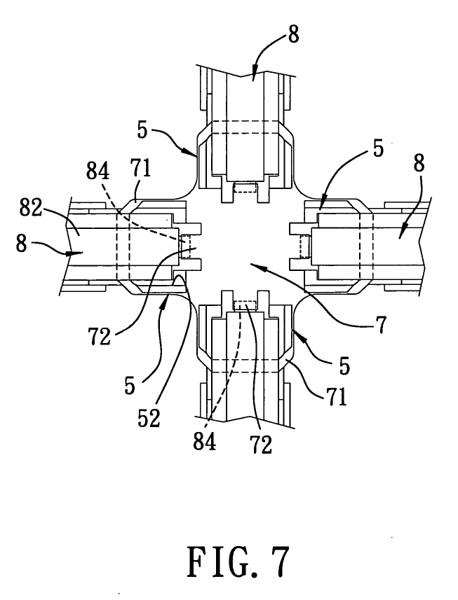

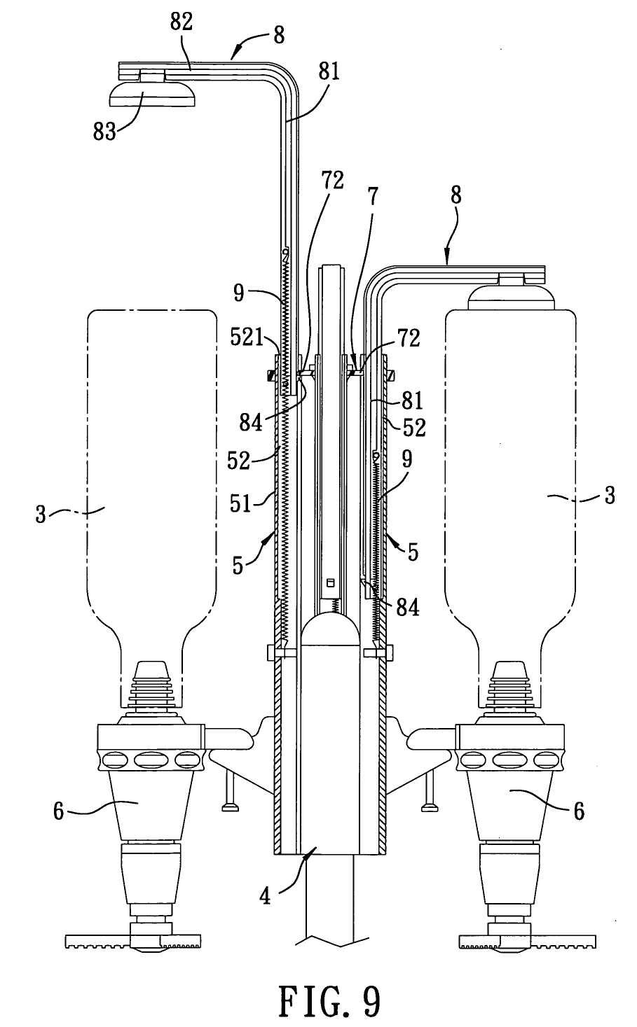

Referring to FIGS. 6 to 8, the positioning unit includes a position-limiting member 7 disposed fixedly on the rail frames 5 and formed with four integral stop blocks 72, each of which extends into the guide slot 52 in a corresponding one of the rail frames 5, and four engaging blocks 84 formed respectively on the insertion rod portions 81 of the operating rods 8 and disposed under the stop blocks 72. Each of the engaging blocks 84 is movable within the guide slot 52 in a corresponding one of the rail frames 5 to engage the corresponding one of the stop blocks 72 so as to prevent removal of the corresponding operating rod 8 from the corresponding rail frame 5 when the corresponding operating rod 8 is moved upwardly, as shown in FIG. 9. In this embodiment, the position-limiting member 7 has four annular limiting portions 71, each of which is sleeved on the vertical rod 51 of the corresponding rail frame 5 and engages the engaging grooves 53 in the corresponding rail frame 5, as shown in FIG. 6.

The following are some of the advantages attributed to the apparatus of the present invention:

1. Engagement between each stop block 72 and the corresponding engaging block 84 can effectively prevent removal of each operating rod 8 from the corresponding rail frame 5 when the operating rods 8 are moved upwardly.

2. Due to the presence of the position-limiting member 7, the rail frames 5 can be stably positioned such that deformation of the rail frames 5 can be avoided during use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An apparatus for controlling supply of liquid contained in a container, the container having an opening, said apparatus comprising:
a base;
an elongate rail frame mounted fixedly and uprightly on said base and formed with an upright guide slot extending downwardly from an upper end of said rail frame;
a controller mounted on a lower end of said rail frame and including an upper inlet portion adapted to engage fittingly the opening of the container so as to allow flow of the liquid from the container into said upper inlet portion, and a lower outlet portion, said controller being operable so as to discharge an amount of the liquid from said lower outlet portion;
an operating rod having an insertion rod portion inserted movably into said guide slot via said upper end of said rail frame, and an abutting rod portion connected integrally to a top end of said insertion rod portion, disposed above said controller, and adapted to abut against the container when the container is disposed between said abutting rod portion of said operating rod and said upper inlet portion of said controller;
a biasing member mounted between said rail frame and said operating rod for biasing the operating rod to move downwardly so as to clamp the container between said abutting rod portion of said operating rod and said controller when the container is disposed between said abutting rod portion of said operating rod and said upper inlet portion of said controller; and
a positioning unit including a position-limiting member disposed fixedly on said rail frame and formed with an integral stop block that extends into said guide slot in said rail frame, and an engaging block formed on said insertion rod portion of said operating rod and disposed under said stop block, said engaging block being movable within said guide slot to engage said stop block so as to prevent removal of said operating rod from said rail frame when said operating rod is moved upwardly.

2. The apparatus as claimed in claim 1, wherein said rail frame includes a U-shaped cross-sectioned vertical rod that is disposed fixedly on said base and that has parallel first wall portions, and a second wall portion interconnecting said first wall portions and cooperating with said first wall portions to define said guide slot, each of said first wall portions having an outer surface formed with parallel first and second lugs that are disposed in proximity to an upper end of said vertical rod and that are spaced apart from each other so as to define an engaging groove therebetween, said position-limiting member having an annular limiting portion that is sleeved on said vertical rod and that engages said engaging grooves of said first wall portions.
